(19) United States
(12) Patent Application Publication
(10) Pub. No.: US 2015/0229464 A1
(43) Pub. Date: Aug. 13, 2015

(54) Baseband Processing of TDD Signals

(71) Applicant: Telefonaktiebolaget L M Ericsson (publ), Stockholm (SE)

(72) Inventors: Elmar Trojer, Taby (SE); Thomas Magesacher, Bromma (SE)

(21) Appl. No.: 14/405,824

(22) PCT Filed: Jun. 29, 2012
(86) PCT No.: PCT/SE2012/050744

§ 371 Date: Dec. 10, 2014

(51) Int. Cl. H04L 5/22; H04B 3/50; H04L 27/26

(52) U.S. Cl. CPC H04L 5/22; H04L 27/265; H04L 27/2636; H04B 3/50

(57) ABSTRACT

Transceiver and method therein, for baseband processing of signals associated with TDD communication over wire lines. The method involves use of a single streaming I/O N/2-point complex FFT kernel for baseband processing of N-sample transmit and receive signal blocks. The processing comprises converting the N-sample signal blocks into intermediate N/2-point signals.

### TECHNICAL FIELD

The herein suggested solution relates to the field of discrete Fourier transform based baseband communication systems, often referred to as discrete multi-tone (DMT) systems, in which transmit and receive signals are separated in time, i.e. using time-division duplexing (TDD).

### BACKGROUND

Copper transmission link technologies such as xDSL are providing, as of today, access broadband services to 286 million subscribers worldwide. Different generations of DSL technology such as ADSL, ADSL2(+), VDSL and VDSL2 provide data rates in the range from several Mb/s up to around 100 Mb/s over ranges from 1 km to 8 km. Recently, the need for Gigabit speeds on telephone-grade copper has arisen for broadband access, home networking, as well as 4G mobile network backhaul, such as e.g. LTE S1/X2 interface backhaul.

New generations of DSL-like systems can provide this capacity on very short lines/loops in the range of 50-200 meters. Such loops provide 100 to 200 MHz of bandwidth for data transmission, as compared to earlier maximum bandwidths of about 30 MHz for legacy systems. Unlike classical DSL systems transmitting uplink and downstream data in different bands of the copper in a frequency-division duplexing scheme (FDD), Gigabit DSL may utilize more hardware-friendly time-division-duplexing (TDD) where upstream and downstream data is utilizing the whole copper spectrum in a time-shared manner—the transceiver either transmits or receives at a given point in time

Block transmission using the Fast Fourier Transform (FFT) and its inverse, IFFT, for modulation and demodulation, respectively, is the dominating modulation scheme, often referred to as multicarrier modulation, in today's communication systems. One of the two most important variants of multicarrier modulation is passband transmission using complex-valued baseband transmit/receive signals, which is referred to as orthogonal frequency division multiplexing (OFDM). OFDM is used, for example, in wireless communication systems, such as LTE. The second one is baseband transmission using real-valued transmit/receive signals, which is referred to as discrete multi-tone (DMT). DMT is used, for example, in wireline communication systems, such as xDSL systems using e.g. copper cables.

An FFT is an efficient method to compute a discrete Fourier transform Xₖ of xₙ given by

Xₖ=c_{FFT}Σₙxₙexp(−j2πkn/N)

where c_{FFT} is a scaling factor.

An IFFT is an efficient method to compute an inverse discrete Fourier transform xₙ of Xₖ given by

xₙ=c_{IFFT}ΣₖXₖexp(j2πkn/N)

where c_{IFFT} is a scaling factor.

A typical choice is c_{FFT}=1 in combination with c_{IFFT}=many mathematical computation packages like, for example, MATLAB, use this pair. Another typical choice is c_{FFT}=N^{-1/2} in combination with c_{IFFT}=N^{-1/2}, which preserves the average per-block power before and after the transform. However, other choices are possible. In an actual implementation, c_{FFT} and c_{IFFT} can for example be influenced by the number representation scheme and/or the required precision for numerical representation, or can also include other scaling factors stemming form one or more blocks in the transceiver chain.

The terms “discrete Fourier transform” and “FFT” used hereinafter refer to transforms with an arbitrary scaling value c_{FFT}. The terms “inverse discrete Fourier transform” and “IFFT” used hereinafter refer to transforms with an arbitrary scaling value c_{IFFT}. For the exemplifying description used hereinafter, the factors c_{FFT}=1 and c_{IFFT}=1/N are used for N-point FFTs/IFFTs and the factors c_{FFT}=1 and c_{IFFT}=2/N are used for N/2-point FFTs/IFFTs. The described method and device, however, can be used with any values for c_{FFT} and c_{IFFT}.

Simultaneous transmission and reception of signals requires a scheme for separating the two signals. Separation in time, also referred to as TDD, is a suitable method for low-complexity, and thus low-cost, transceiver implementations. The cost can be kept low, e.g. since there is a reduced need for echo cancellation when using TDD, as compared to when using frequency division. Examples of TDD communication systems include e.g. transmission over any kind of copper transmission media, such as twisted pair, CAT5, etc. TDD systems may be used for various applications providing various services, such as e.g. Internet access and base-station backhaul. The communication may be, and is being, standardized in different variants, such as G.fast and G.hn, but may also be used in different non-standardized forms.

Discrete Fourier transform based baseband communication systems require fast-enough digital signal processing for performing FFT and IFFT. While direct implementation of an N-point discrete Fourier transform sum requires N² significant operations, dedicated FFT algorithms have a complexity in the order of N log N significant operations. Exact numbers are strongly dependent on the actual implementation. From a hardware-implementation perspective, there are two fundamentally different architectures for FFT/IFFT implementation, which are also illustrated in FIG. 1 and FIG. 2:
1. Pipelined input/output (I/O): also denoted “streaming I/O”. Implementing the FFT algorithm in a pipeline fashion allows continuous operation where input and output samples of blocks continuously enter and leave the FFT unit one by one at a clock frequency, which equals the block frequency divided by the block length in samples. Thus, it takes one block length to clock in (or clock out) an entire block, as illustrated in FIG. 1. Pipelined architectures are costly in terms of logic and memory but allow continuous transformation of blocks without gaps.
2. Burst I/O: Both input blocks and output blocks are buffered before (load) and after (unload) the actual transform, respectively. Loading and unloading of buffers can be done simultaneously, as illustrated in FIG. 2. Burst I/O FFTs are cheap in terms of logic and memory, but require gaps, 202, of one block length between transforms for loading/unloading the buffers.

Emerging wireline standards propose values for N, in the order of 10⁴. For systems with such long blocks, FFT/IFFT processing dominates complexity in multicarrier transceivers. In state of the art architectures, the FFT block in a transceiver device supports streaming I/O capability in order to be able to perform a transform in any symbol period. The streaming I/O FFT block is very expensive in terms of hardware resources.

### SUMMARY

It would be desirable to reduce complexity and hardware costs for transceiver equipment. It is an object of the herein suggested technology to reduce the complexity, and thereby the hardware cost, of transceiver equipment for wireline communication. Herein it is suggested to use a single streaming I/O N/2-point complex FFT kernel or architecture for providing multicarrier modulation and demodulation of N-sample signals blocks. It is anticipated that the hardware cost related to the baseband multicarrier modulation and demodulation could be reduced by about 15% by use of the herein suggested solution, and the memory savings are anticipated to be about 60% or more, as compared to a 2-kernel burst-I/O architecture.

According to a first aspect, a method is provided for baseband processing of signals associated with TDD communication over one or more wire lines. The method is to be performed by a transceiver operable to communicate over wire lines. In regard of received signals, the method comprises converting a real-valued N-sample time-domain receive signal block rₙ into a signal zₙ comprising N/2 complex points, and further performing a complex FFT on the signal zₙ. The complex FFT is performed using a single streaming I/O N/2-point complex FFT kernel, thus providing a signal Zₖ comprising N/2 complex points. The method further comprises deriving the N-point discrete Fourier transform, Rₖ, of the signal block rₙ from the signal Zₖ. In regard of a transmit signal, the method comprises converting a complex Hermitian-symmetric N-sample frequency-domain transmit signal block Tₖ into a signal Z′ₖ comprising N/2 complex points, and further performing a complex FFT on the signal Z′ₖ using the streaming I/O N/2-point complex FFT kernel, thus providing a signal z′ₙ comprising N/2 complex points. The method further comprises deriving the N-point inverse discrete Fourier transform, tₙ, of the signal Tₖ from the signal z′ₙ.

According to a second aspect, a transceiver is provided, for baseband processing of signals associated with TDD communication over one or more wire lines. The transceiver comprises a converting unit (706), adapted to convert a real-valued N-sample time-domain receive signal block rₙ into a signal zₙ comprising N/2 complex points, and further adapted to convert a complex Hermitian-symmetric N-sample frequency-domain transmit signal block Tₖ into a signal Z′ₖ comprising N/2 complex points. The transceiver further comprises a streaming I/O N/2-point complex FFT kernel, adapted to perform a complex FFT on any of the signals zₙ and Z′ₖ, thus providing a signal Zₖ or z′ₙ comprising N/2 complex points. The transceiver further comprises a deriving unit, adapted to derive the N-point discrete Fourier transform, Rₖ, of the signal block rₙ from the signal Zₖ; and further adapted to derive the N-point inverse discrete Fourier transform, tₙ, of the signal Tₖ from the signal z′ₙ.

The above method and transceiver enables a reduction of hardware cost, as compared to previously known methods and transceivers.

The above method and transceiver may be implemented in different embodiments. Examples of the converting and deriving will be described in detail herein and in the appendix.

According to a third aspect, the use of a single streaming I/O N/2-point complex FFT kernel is provided, in a transceiver, for baseband processing of N-sample transmit and receive signal blocks associated with TDD communication over one or more wire lines. The baseband processing comprises converting the N-sample signal blocks into intermediate N/2-point signals.

According to a fourth aspect, a computer program is provided, which comprises computer readable code means, which when run in a transceiver according to the second aspect above causes the transceiver to perform the corresponding method according to the first aspect above.

According to a fifth aspect, a computer program product is provided, comprising a computer program according to the fourth aspect.

### BRIEF DESCRIPTION OF THE DRAWINGS

The suggested technology will now be described in more detail by means of exemplifying embodiments and with reference to the accompanying drawings, in which:

FIG. 1 illustrates so-called pipelined or streaming I/O architecture, according to the prior art.

FIG. 2 illustrates so-called burst I/O architecture, according to the prior art.

FIG. 3 illustrates an arrangement according to an exemplifying embodiment as compared to a prior art solution.

FIGS. 4 and 5 are illustrations of the signal blocks and actions associated with receive blocks (4) and transmit blocks (5).

FIG. 6 is a flow chart illustrating a procedure according to an exemplifying embodiment.

FIG. 7 is a block chart illustrating a transceiver according to an exemplifying embodiment.

FIG. 8 is a block chart illustrating an arrangement according to an exemplifying embodiment.

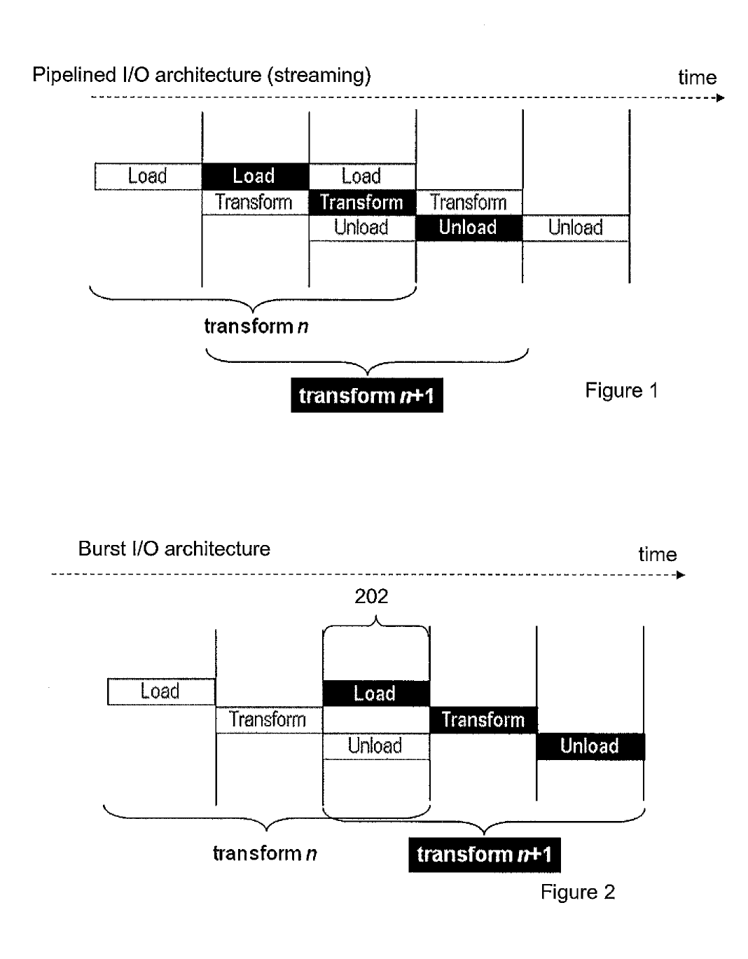

### DETAILED DESCRIPTION

A DMT multicarrier transceiver has two basic functions:
1. Transmit (tx): a complex-valued frequency-domain transmit block T is transformed into a real-valued time-domain transmit block t, which is achieved by applying an IFFT.
2. Receive (rx): a real-valued time-domain receive block r is transformed into a complex-valued frequency-domain receive block R, which is achieved by applying an FFT.

The solution described herein enables computing of both a real-valued N-point FFT (RFFT) and a real-valued N-point IFFT (RIFFT) with a single N/2-point streaming-I/O transform and some pre- and post-processing. RFFT implies that N real points are transformed into N complex Hermitian symmetric points, and IFFT implies that N complex Hermitian symmetric points are transformed into N real points. The N/2-point streaming-I/O transform operates continuously and arbitrary FFT/IFFT scheduling is possible.

Regarding the terminology, the term “sample” and “point” are both used to refer to a signal point, as in “N-sample” or “N-point”. Herein, “sample” will be used in relation to the receive and transmit blocks r and T, and the term “point” will be used in relation to the intermediate signals, z, Z, and mostly in relation to the transformed signals R and t. However, the term “point” could alternatively be used also for the samples of the receive and transmit blocks. Correspondingly, the term “sample” could be used for other signal points.

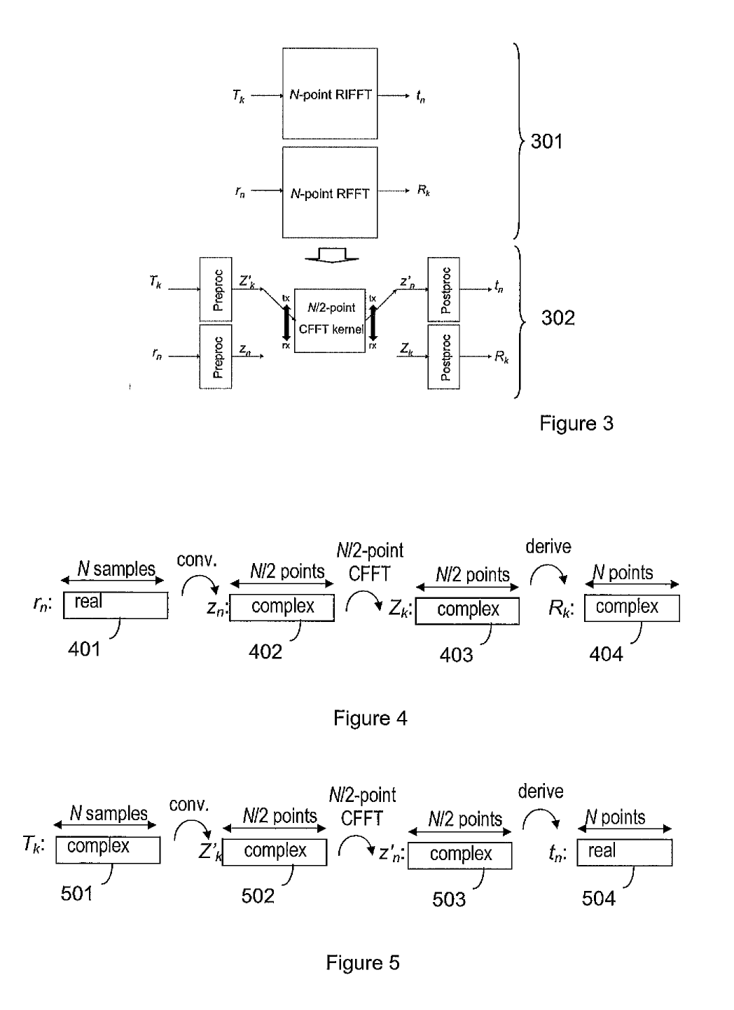

When considering previously known solutions, the FFT/IFFT functionality would be implemented using one of the following architectures. Numbers for the relation MAC blocks/memory blocks are given for a typical FPGA-based implementation of a system with N/2=4096 subcarriers. However, other values of N are possible. Regarding the value N/2=4096, this is based on that, with subcarrier spacing F_{SC}, a time-domain block consists of N=8192 real-valued samples at sampling frequency F_{SC} N resulting in a block-length of N/(F_{SC} N)=1/F_{SC}, when windowing and cyclic prefix/suffix are disregarded:
Architecture A1: Two N-point (8 k) burst I/O FFT kernels, i.e. one per direction rx/tx: 18/44. This architecture is illustrated in the upper part of FIG. 3 as architecture 301.
Architecture A2: One N-point (8 k) streaming I/O FFT kernel shared between directions rx/tx: 18/21.

Herein, the following architecture is suggested:

### Proposed Architecture:

One N/2-point (4 k) streaming I/O FFT kernel: 15/9 exploiting Hermitian symmetry+pre/post processing. The suggested architecture is schematically illustrated in the lower part of FIG. 3 as architecture 302.

That is, instead of using two N-point FFT kernels as in A1, or sharing one streaming I/O N-point FFT kernel as in A2, the proposed solution needs only one streaming I/O N/2-point FFT kernel. The proposed architecture has lower complexity and lower memory requirements than the architectures A1 and A2 above. Further, it should be noted that the suggested solution entirely avoids a modulator/mixer stage. The different signal blocks and actions involved in the suggested solution are schematically illustrated in FIGS. 4 and 5. The notation and mathematical expressions for one exemplifying implementation of the suggested solution is provided in the appendix to this description.

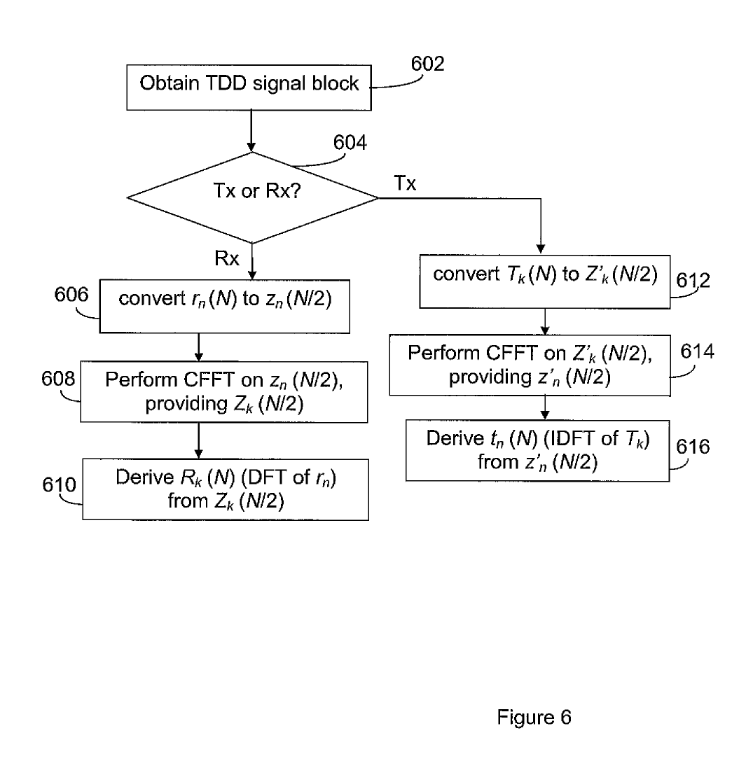

### Exemplifying Procedure, FIG. 6

Below, an exemplifying procedure for baseband processing of signals associated with TDD multicarrier communication over one or more wire lines will be described with reference to FIG. 6. The procedure is assumed to be performed by a transceiver or transceiving node in a communication system, such as e.g. an xDSL-system employing DMT. The wire line or lines may be assumed to be metallic, e.g. copper, cables, such as e.g. twisted pair, CAT 5, coaxial cables or galvanic connections, such as e.g. backplane busses, on-board inter-chip connection busses, or similar

As previously described, the transceiver handles received blocks, r, and blocks T, which are to be transmitted. The actions associated with receive blocks and transmit blocks, respectively, are different. In FIG. 6, the selection of the correct actions is illustrated by an action 604. The obtaining of a receive block or a transmit block is illustrated as action 602.

In case of a received signal, a real-valued N-sample time-domain receive signal block rₙ is converted, in an action 606, into a signal zₙ comprising N/2 complex points. A complex FFT is performed on the signal zₙ, in an action 608, using a streaming I/O N/2-point complex FFT kernel. Thereby, a signal Zₖ is provided, which comprises N/2 complex points. Then, in an action 610, the N-point discrete Fourier transform, Rₖ, of the signal block rₙ is derived from the signal Zₖ.

In case of a transmit signal, i e. a signal to be transmitted, a complex Hermitian-symmetric N-sample frequency-domain transmit signal block Tₖ is converted into a signal Z′ₖ, in an action 612, where Z′ₖ comprises N/2 complex points. A complex FFT is performed on the signal Z′ₖ, in an action 614, using the streaming I/O N/2-point complex FFT kernel. Thereby, a signal z′ₙ is provided, which comprises N/2 complex points. Then, in an action 616, the N-point inverse discrete Fourier transform, tₙ, of the signal block Tₖ is derived from the signal z′ₙ.

The action 606 comprises arranging every second sample of rₙ as real part of zₙ and the remaining samples of rₙ as imaginary part of zₙ, such as (for details on notation and equations herein, see appendix):

Zₙ=r₂ₙ+jr₂ₙ₊₁, n=0,1, . . . ,(N/2)−1

This could alternatively be described as splitting the receive length-N signal block rₙ into two length-N/2 blocks, r⁽¹⁾ and r⁽²⁾, where block r⁽¹⁾ contains every second sample of rₙ and the other block r⁽²⁾ contains the remaining samples; and then constructing the signal zₙ as zₙ=r⁽¹⁾+jr⁽²⁾

The action 610 comprises converting Zₖ into two length-N blocks, Rₖ⁽¹⁾ and Rₖ⁽²⁾, where the block Rₖ⁽¹⁾ corresponds to an FFT of a block r⁽¹⁾, obtained by setting all even-index samples of rₙ to 0, and block Rₖ⁽²⁾ corresponds to an FFT of a block r⁽²⁾, obtained by setting all odd-index samples of rₙ to 0. The action 610 further comprises computing Rₖ as an element-wise sum of Rₖ⁽¹⁾ and Rₖ⁽²⁾.

One way of implementing this could be mathematically described as:

$${R}_{k} = \frac{1}{2} ( {Z}_{k} + {Z}_{{N}_{2} - k}^{*} - j ( {Z}_{k} - {Z}_{{N}_{2} - k}^{*} ) {e}^{- j2π k / N} ) , \\ k = 0 , 1 , … , \frac{N}{2} ;$$

$$where$$

$${N}_{2} = \frac{N}{2} .$$

An alternative way of describing action 610 could be as follows: constructing the length-N/2 FFTs, Rₖ⁽¹⁾ and Rₖ⁽²⁾ of r⁽¹⁾ and r⁽²⁾, respectively (see above), using even and odd parts of both the real and the imaginary part of Zₖ. The real part of the FFT of the real part of zₙ is the even part of the real part of Zₖ and the imaginary part of the FFT of the real part of zₙ is the odd part of the imaginary part of Zₖ; the real part of the FFT of the imaginary part of zₙ is the even part of the imaginary part of Zₖ and the imaginary part of the FFT of the imaginary part of zₙ is the odd part of the real part of Zₖ. Then, the length-N FFT Rₖ of rₙ may be computed as a sum of the length-N block Rₖ⁽¹⁾ and a length-N block Rₖ⁽³⁾ obtained by element-wise multiplication of Rₖ⁽²⁾ with a length-N block containing the constants exp(−j2πk/N), k=0, . . . , N−1.

The action 612 comprises converting Tₖ into two length-N/2 blocks, Tₖ⁽¹⁾ and Tₖ⁽²⁾, where block Tₖ⁽¹⁾ corresponds to the FFT of a block t⁽¹⁾ comprising all even-index samples of the IFFT of Tₖ and where the other block Tₖ⁽²⁾ corresponds to the FFT of a block t⁽²⁾ comprising all odd-index samples of the IFFT of Tₖ, and converting the real and imaginary parts of Tₖ⁽¹⁾ and Tₖ⁽²⁾ into Z′ₖ such that the real part of the FFT of Z′ₖ will correspond to t⁽¹⁾ and the imaginary part of the FFT of Z′ₖ will correspond to t⁽²⁾.

One way of implementing this could be mathematically described as:

$${Z}_{k}^{′} = \frac{1}{2} ( {T}_{k}^{*} + {T}_{{N}_{2} - k} - j ( {T}_{k}^{*} - {T}_{{N}_{2} - k} ) {e}^{- j2π k / N} ) , \\ k = 0 , 1 , … , \frac{N}{2} - 1 , \\ where$$

$${N}_{2} = \frac{N}{2}$$

The action 616 comprises arranging the real part of z′ₙ as every second sample of tₙ and the imaginary part of z′ₙ as remaining samples of tₙ. This could be mathematically described as:

$${t}_{n} = \{ \begin{matrix}\frac{1}{{N}_{2}} ℜ ( {z}_{\frac{n}{2}}^{′} ) , & n mod 2 = 0 \\ - \frac{1}{{N}_{2}} ( {z}_{\frac{n - 1}{2}}^{′} ) , & n mod 2 = 1\end{matrix} , \\ n = 0 , 1 , … , N - 1 \\ where \\ {N}_{2} = \frac{N}{2}$$

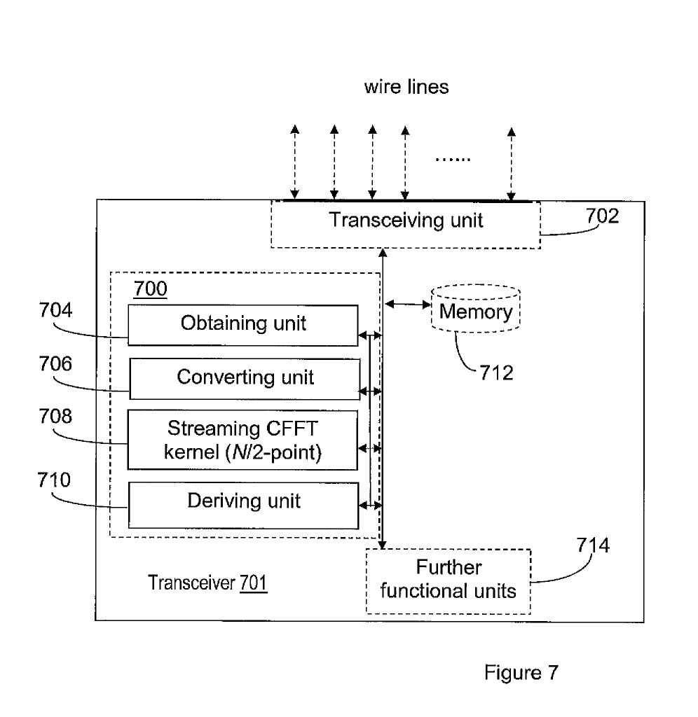

### Exemplifying Transceiver, FIG. 7

Below, an exemplifying transceiver 701, adapted to enable the performance of the above described procedure for baseband processing, will be described with reference to FIG. 7. The transceiver 701 is operable in a communication system using TDD multicarrier communication over one or more wire lines. The transceiver 701 may be e.g. a DSLAM or a CPE, or some other network node. For example, the transceiver could be base station in a wireless communication system, using one or more wire lines for backhaul. As previously stated, the wire line or lines may be assumed to be metallic, e.g. copper, cables, such as e.g. twisted pair, CAT 5, coaxial cables or galvanic connections, such as e.g. backplane busses, on-board inter-chip connection busses, or similar

The transceiver 701 is illustrated as to communicate over wire lines using a communication unit, or line driver unit, 702, comprising a receiver 704 and a transmitter 703. The transceiver 701 may comprise functional units 714, such as e.g. functional units providing regular communication functions, and may further comprise one or more storage units 712.

The arrangement 700 and/or transceiver 701, or parts thereof, could be implemented e.g. by one or more of: a Programmable Logic Device (PLD), such as FPGA or ASIC; a processor or a micro processor and adequate software and memory for storing thereof, or other electronic component(s) or processing circuitry configured to perform the actions described above.

The transceiver 701 could be described and illustrated as comprising an obtaining unit, adapted to obtain the signal blocks, which are to be processed. Receive signal blocks, r, may be received, e.g. from another entity or network node via the unit 702, and transmit signal blocks, T, which are to be transmitted over the wire lines, may be received from a baseband part of the device 701.

The transceiver 701 comprises a converting unit, 706, adapted to convert an obtained N-sample signal block, r or T, into a signal X, i.e. z or Z′, comprising N/2 complex points. The obtained N-sample signal block, is either a real-valued time-domain receive signal block r, or a complex Hermitian-symmetric frequency-domain transmit signal block T. The transceiver 701 further comprises a streaming I/O N/2-point complex FFT kernel 708, adapted to perform a complex FFT on the signal X, thus providing a signal X′_{CFFT} comprising N/2 complex points. The transceiver 701 further comprises a deriving unit 710, adapted to derive, from the signal X′_{CFFT}, an N-point discrete Fourier transform R, when the obtained signal block was a receive block r, and, to derive an N-point inverse discrete Fourier transform t, when the obtained signal block was a transmit block T. It should be noted that the deriving does not involve any performing of an FFT or IFFT.

The operations performed by the converting unit and deriving unit are of low computational complexity. The converting and deriving may be achieved by use of only low-complexity operations, such as shift operations and additions, which is very beneficial from a hardware perspective. The converting and deriving does not need to involve any complex multiplications.

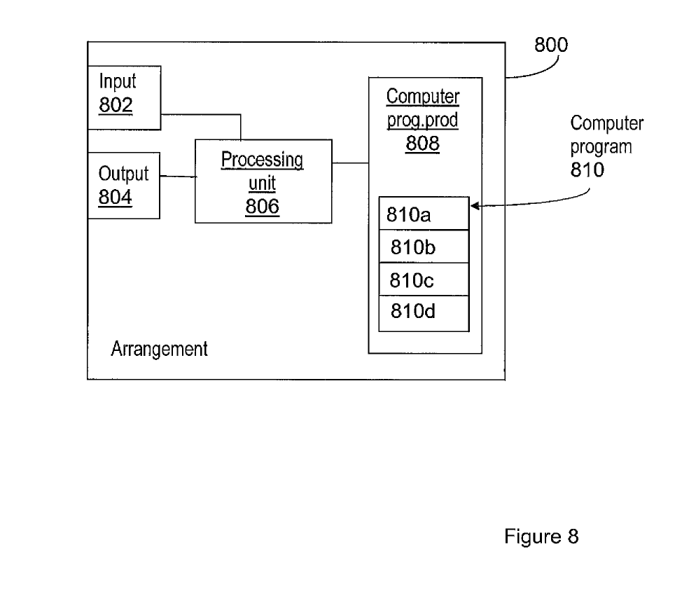

### Exemplifying Arrangement, FIG. 8

FIG. 8 schematically shows a possible embodiment of an arrangement 800, which also can be an alternative way of disclosing an embodiment of the arrangement 1700 in the transceiver 1701 illustrated in FIG. 17, or at least part of it. Comprised in the arrangement 800 are here a processing unit 806, e.g. with a DSP (Digital Signal Processor). The processing unit 806 may be a single unit or a plurality of units to perform different actions of procedures described herein. The processing unit may comprise a streaming I/O N/2-point complex FFT kernel, e.g. in form of a dedicated integrated circuit. The arrangement 800 may also comprise an input unit 802 for receiving signals from other entities or nodes, and an output unit 804 for providing signals to other entities or nodes. The input unit 802 and the output unit 804 may be arranged as an integrated entity.

Furthermore, the arrangement 800 comprises at least one computer program product 808 in the form of a memory, e.g. an EEPROM (Electrically Erasable Programmable Read-Only Memory), a flash memory and a hard drive. The computer program product 808 comprises a computer program 810, which comprises code means, which when executed in the processing unit 806 in the arrangement 800 causes the arrangement and/or a node in which the arrangement is comprised to perform the actions e.g. of the procedure described earlier in conjunction with FIG. 6.

The computer program 810 may be configured as a computer program code structured in computer program modules. Hence, in an exemplifying embodiment, the code means in the computer program 810 of the arrangement 800 may comprise an obtaining module 810a for obtaining a request for a bearer setup or an indication thereof. The arrangement 800 may further comprise a converting module 810b for converting a real-valued N-sample time-domain receive signal block rₙ into a signal zₙ comprising N/2 complex points, and further adapted to convert a complex Hermitian-symmetric N-sample frequency-domain transmit signal block Tₖ into a signal Z′ₖ comprising N/2 complex points.

The computer program may further comprise a deriving module 810c for deriving the N-point discrete Fourier transform, Rₖ, of the signal block rₙ from the signal Zₖ; and further adapted to derive the N-point inverse discrete Fourier transform, tₙ, of the signal Tₖ from the signal z′ₙ. The computer program 810 may further comprise one or more additional modules 810d, e.g. a streaming I/O N/2-point FFT module for performing the FFT. However, in a preferred solution, the FFT is performed by dedicated hardware.

Although the code means in the embodiment disclosed above in conjunction with FIG. 8 are implemented as computer program modules which when executed in the processing unit causes the arrangement or transceiver to perform the actions described above in the conjunction with figures mentioned above, at least one of the code means may in alternative embodiments be implemented at least partly as hardware circuits.

A previously mentioned, the processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the transceiver 701.

While the method and network node or arrangement for baseband processing as suggested above has been described with reference to specific embodiments provided as examples, the description is generally only intended to illustrate the suggested technology and should not be taken as limiting the scope of the suggested methods and arrangements, which are defined by the appended claims. While described in general terms, the method and arrangement may be applicable e.g. for different types of communication systems applying multicarrier TDD over wire lines.

It is also to be understood that the choice of interacting units or modules, as well as the naming of the units are only for exemplifying purpose, and nodes suitable to execute any of the methods described above may be configured in a plurality of alternative ways in order to be able to execute the suggested process actions. It should also be noted that the units or modules described in this disclosure are to be regarded as logical entities and not with necessity as separate physical entities.

### ABBREVIATIONS

DMT discrete multi-tone
DFT discrete Fourier transform
FFT fast Fourier transform
IFFT inverse FFT
I/O input/output
OFDM orthogonal frequency-division multiplexing
TDD time division duplexing.

### APPENDIX

Notation and exemplifying pre/post processing apparatus functions are described here.

### Notation:

Lower-case and upper case symbols denote time domain and frequency domain points, respectively [symbol] (•) and [symbol] (•) denote real and imaginary part of (•) respectively. (•)* denotes the complex conjugate of (•).

The following symbols are uses
N block length (No. of time-domain samples)
N₂:=N/2 CFFT size
rₙ, n=0, 1, . . . , N−1 real-valued length N time domain receive block
Rₖ, k=0, 1, . . . , N−1 Hermitian symmetric (Rₖ=R*_{N-k}) length-N frequency domain receive block (N-point discrete Fourier Transform (DFT) of rₙ):

$${R}_{k} := {\sum }_{n = 0}^{N - 1} {r}_{n} {e}^{- j2π kn / N} , \\ k = 0 , 1 , … , N - 1 \qquad ( 1 )$$

Tₖ, k=0, 1, . . . , N−1 Hermitian-symmetric (Tₖ=T*_{N-k}) length-N frequency domain transmit block
tₙ, n=0, 1, . . . , N−1 real-valued length-N time-domain transmit block (N-point inverse DFT of Tₖ):

$${t}_{n} := \frac{1}{N} {\sum }_{k = 0}^{N - 1} {T}_{k} {e}^{j2π kn / N} , \\ n = 0 , 1 , … , N - 1 \qquad ( 2 )$$

zₙ, n=0, 1, . . . , N₂−1 CFFT input (N₂ complex points), receive
Zₖ, k=0, 1, . . . , N₂−1 CFFT output (N₂ complex points), receive
z′ₙ, n=0, 1, . . . , N₂−1 CFFT output (N₂ complex points), transmit
Z′ₖ, k=0, 1, . . . , N₂−1 CFFT input (N₂ complex points), transmit

### Receive Processing:

1) Pre-processing: Compute

zₙ=r₂ₙ+jr₂ₙ₊₁, n=0,1, . . . , N₂−1 (3)

2) FFT: Compute the N₂-point DFT Zₖ, k=0, 1, . . . , N₂−1 of zₙ, n=0, 1, . . . , N₂−1 using the CFFT kernel:

$${Z}_{k} = {\sum }_{n = 0}^{{N}_{2} - 1} {z}_{n} {e}^{- j2π kn / {N}_{2}} , \\ k = 0 , 1 , … , {N}_{2} - 1 \qquad ( 4 )$$

3) Post-processing: Compute

$${R}_{k} = \frac{1}{2} ( {Z}_{k} + {Z}_{{N}_{2} - k}^{*} - j ( {Z}_{k} - {Z}_{{N}_{2} - k}^{*} ) {e}^{- j2π k / N} ) , \\ k = 0 , 1 , … , {N}_{2} \qquad ( 5 )$$

Note that (Zₖ+Z*_{N}_{₂}₋ₖ)|ₖ₌₀=(Zₖ+Z*_{N}_{₂}₋ₖ)|_{k=N}_{₂}=2 [symbol] (Z₀) as well as (Zₖ−Z*_{N}_{₂}₋ₖ)|ₖ₌₀=(Zₖ+Z*_{N}_{₂}₋ₖ)|_{k=N}_{₂}=j2 [symbol] (Z₀).

### Transmit Processing:

1) Pre-processing: Compute

$${Z}_{k}^{′} = \frac{1}{2} ( {T}_{k}^{*} + {T}_{{N}_{2} - k} - j ( {T}_{k}^{*} - {T}_{{N}_{2} - k} ) {e}^{- j2π k / N} ) , \\ k = 0 , 1 , … , {N}_{2} - 1 \qquad ( 6 )$$

2) FFT: Compute the N₂-point DFT z′ₙ, n=0, 1, . . . , N₂−1 of Z′ₖ, k=0, 1, . . . , N₂−1 using the CFFT kernel:

$${z}_{n}^{′} = {\sum }_{l = 0}^{{N}_{2} - 1} {Z}_{k}^{′} {e}^{- j2π kn / {N}_{2}} , \\ n = 0 , 1 , … , {N}_{2} - 1 \qquad ( 7 )$$

3) Post-processing: Compute

$${t}_{n} = \{ \begin{matrix}\frac{1}{{N}_{2}} ℜ ( {z}_{\frac{n}{2}}^{′} ) , & n mod 2 = 0 \\ - \frac{1}{{n}_{2}} ( {z}_{\frac{n - 1}{2}}^{′} ) , & n mod 2 = 1\end{matrix} , \\ n = 0 , 1 , … , N - 1 \qquad ( 8 )$$

Pre processing requires roughly N/2 complex MACs (roughly 2N real MACs).
Post processing requires roughly N/2 complex MACs (roughly 2N real MACs).

1. Method in a transceiver, for baseband processing of signals associated with Time Division Duplexing, TDD, communication over one or more wire lines, the method comprising:
for a received signal:
converting a real-valued N-sample time-domain receive signal block rₙ into a signal zₙ comprising N/2 complex points;
performing a complex FFT on the signal zₙ using a streaming I/O N/2-point complex FFT kernel, thus providing a signal Zₖ comprising N/2 complex points;
deriving the N-point discrete Fourier transform, Rₖ, of the signal block rₙ from the signal Zₖ,
for a transmit signal:
converting a complex Hermitian-symmetric N-sample frequency-domain transmit signal block Tₖ into a signal Z′ₖ comprising N/2 complex points;
performing a complex FFT on the signal Z′ₖ using the streaming I/O N/2-point complex FFT kernel, thus providing a signal z′ₙ comprising N/2 complex points;
deriving the N-point inverse discrete Fourier transform, tₙ, of the signal Tₖ from the signal z′ₙ.

2. Method according to claim 1, wherein the converting involves:
for a received signal:
arranging every second sample of rₙ as real part of zₙ and the remaining samples of rₙ as imaginary part of zₙ;
for a transmit signal:
converting Tₖ into two length-N/2 blocks, Tₖ⁽¹⁾ and Tₖ⁽²⁾, where block Tₖ⁽¹⁾ corresponds to an FFT of a block t⁽¹⁾ comprising all even-index samples of an IFFT of Tₖ and where the other block Tₖ⁽²⁾ corresponds to an FFT of a block t⁽²⁾ comprising all odd-index samples of an IFFT of Tₖ, and
converting the real and imaginary parts of Tₖ⁽¹⁾ and Tₖ⁽²⁾ into Z′ₖ such that the real part of an FFT of Z′ₖ will correspond to t⁽¹⁾ and the imaginary part of an FFT of Z′ₖ will correspond to t⁽²⁾.

3. Method according to claim 1, wherein the deriving involves:
for a received signal:
converting Zₖ into two length-N blocks, Rₖ⁽¹⁾ and Rₖ⁽²⁾, where one block Rₖ⁽¹⁾ corresponds to an FFT of a block r⁽¹⁾ which can be obtained by setting all even-index samples of rₙ to 0 and where the other block Rₖ⁽²⁾ corresponds to an FFT of a block r⁽²⁾ which can be obtained by setting all odd-index samples of rₙ to 0, and
computing an element-wise sum of Rₖ⁽¹⁾ and Rₖ⁽²⁾;
for a transmit signal:
arranging the real part of z′ₙ as every second sample of tₙ and the imaginary part of z′ₙ as remaining samples of tₙ.

4. Method according to claim 1, wherein the deriving involves:
for a received signal:
converting Zₖ into two length-N blocks, Rₖ⁽¹⁾ and Rₖ⁽²⁾, where one block Rₖ⁽¹⁾ corresponds to an FFT of a block r⁽¹⁾ which can be obtained by setting all even-index samples of rₙ to 0 and where the other block Rₖ⁽²⁾ corresponds to an FFT of a block r⁽²⁾ which can be obtained by setting all odd-index samples of rₙ to 0, and
computing an element-wise sum of Rₖ⁽¹⁾ and Rₖ⁽²⁾;
for a transmit signal:
multiplying the real part of z′ₙ by a scaling factor c_{IFFT} and arranging it as every second sample of tₙ and multiplying the imaginary part of z′ₙ by c_{IFFT} and arranging it as remaining samples of tₙ.

5. Method according to claim 1, wherein the TDD multicarrier communication is performed over one or more wire lines of metal.

6. Method according to claim 1, used in a communication system operating according to communication standard G.fast.

7. Transceiver for baseband processing of signals associated with Time Division Duplexing, TDD, communication over one or more wire lines, the arrangement comprising:
a converting unit, adapted to convert a real-valued N-sample time-domain receive signal block rₙ into a signal zₙ comprising N/2 complex points, and further adapted to convert a complex Hermitian-symmetric N-sample frequency-domain transmit signal block Tₖ into a signal Z′ₖ comprising N/2 complex points;
a streaming I/O N/2-point complex FFT kernel, adapted to perform a complex FFT on any of the signals zₙ and Z′ₖ, thus providing a signal Zₖ or z′ₙ comprising N/2 complex points;
a deriving unit, adapted to derive the N-point discrete Fourier transform, Rₖ, of the signal block rₙ from the signal Zₖ; and further adapted to derive the N-point inverse discrete Fourier transform, tₙ, of the signal Tₖ from the signal z′ₙ.

8. Transceiver according to claim 7, wherein the converting involves:
for a received signal:
arranging every second sample of rₙ as real part of zₙ and the remaining samples of rₙ as imaginary part of zₙ.
for a transmit signal:
converting Tₖ into two length-N/2 blocks, Tₖ⁽¹⁾ and Tₖ⁽²⁾, where block Tₖ⁽¹⁾ corresponds to the FFT of a block t⁽¹⁾ comprising all even-index samples of the IFFT of Tₖ and where the other block Tₖ⁽²⁾ corresponds to the FFT of a block t⁽²⁾ comprising all odd-index samples of an IFFT of Tₖ, and
converting the real and imaginary parts of T/r⁽¹⁾ and Tₖ⁽²⁾ into Z′ₖ such that that the real part of an FFT of Z′ₖ will correspond to t⁽¹⁾ and the imaginary part of the FFT of Z′ₖ will correspond to t⁽²⁾.

9. Transceiver according to claim 7, wherein the deriving involves:
for a received signal:
converting Zₖ into two length-N blocks, Rₖ⁽¹⁾ and Rₖ⁽²⁾, where one block Rₖ⁽¹⁾ corresponds to the FFT of a block r⁽¹⁾ which can be obtained by setting all even-index samples of rₙ to 0 and where the other block Rₖ⁽²⁾ corresponds to the FFT of a block r⁽²⁾ which can be obtained by setting all odd-index samples of rₙ to 0, and
computing an element-wise sum of Rₖ⁽¹⁾ and Rₖ⁽²⁾.
for a transmit signal:
arranging the real part of z′ₙ as every second sample of tₙ and the imaginary part of z′ₙ as remaining samples of tₙ.

10. Transceiver according to claim 7, wherein the deriving involves:
for a received signal:
converting Zₖ into two length-N blocks, Rₖ⁽¹⁾ and Rₖ⁽²⁾, where one block Rₖ⁽¹⁾ corresponds to the FFT of a block r⁽¹⁾ which can be obtained by setting all even-index samples of rₙ to 0 and where the other block Rₖ⁽²⁾ corresponds to the FFT of a block r⁽²⁾ which can be obtained by setting all odd-index samples of rₙ to 0, and
computing an element-wise sum of Rₖ⁽¹⁾ and Rₖ⁽²⁾.
for a transmit signal:
multiplying the real part of z′ₙ by a scaling factor c_{IFFT} and arranging it as every second sample of tₙ and multiplying the imaginary part of z′ₙ by c_{IFFT} and arranging it as remaining samples of tₙ.

11. Transceiver according to claim 7, adapted to perform the TDD multicarrier communication over one or more wire lines of metal.

12. Transceiver according to claim 7, used in a communication system operating according to communication standard G.fast.

13. Use of a single streaming I/O N/2-point complex FFT kernel in a transceiver, for baseband processing of N-sample transmit and receive signal blocks associated with Time Division Duplexing, TDD, communication over one or more wire lines, wherein the processing comprises converting the N-sample signal blocks into intermediate N/2-point signals.

14. Computer program, comprising computer readable code means, which when run in a transceiver according to claim 7 causes the transceiver to perform the corresponding method.

15. Computer program product comprising computer program according to claim 14.
